(19) United States
(12) Patent Application Publication
(10) Pub. No.: US 2008/0066312 A1
(43) Pub. Date: Mar. 20, 2008

(54) Heat Induced Interference Fit for Structural Purposes in Vehicles

(76) Inventor: Adam Armido Donato, (US)

Correspondence Address: Adam Donato, 337 Little Quarry Road, Gaithersburg, MD, 20878, US

(21) Appl. No.: 11/530,475

(22) Filed: Sep. 10, 2006

(51) Int. Cl. B21D 53/88; B23P 11/02

(52) U.S. Cl. 29/897.2; 29/447

(57) ABSTRACT

A process for joining components of desired materials for structural purposes in the construction of a vehicle, such as a bicycle, scooter, motorcycle, moped, car, truck, trolley, pushcart, or other such vehicle of motion as powered by an individual, engine, or motor, through the use of an interference fit as a result of utilizing the thermal expansion properties of the materials. This process is an improvement upon conventional practices requiring some manner of melting a material to create a joint.

### FIELD OF INVENTION

The field of the invention relates to the assembly of structural components of vehicles of motion.

### BACKGROUND OF THE INVENTION

Currently the structural components of vehicles of motion are primarily assembled and joined by some means of melting a material to create the joint. This melted material may be the material that is being joined or it may be an introduced material. The melted material may be the only means of support at the joint or an additional support may be introduced into the joint which will then be secured by means of a melted material.

Any process that relies upon a melted material to create a joint has several inherent weaknesses. Many metals suffer a decrease in structural integrity due to the phase changes induced by the heat required to melt a material at the joint. This phase change requires that a post-process heat treatment take place to restore desired material properties to the joint in questions. These heat treatments can be costly and time-consuming.

Joining through melted material is not an exact technique. A melted material joint rarely has the strength of the components to which it has been formed. Thus the joint from this process is often the weakest point in a structural assembly. To compensate for this, excess material is often introduced at the joint site, allowing for a larger area to melt material over. The introduction of excess material will increase the weight of the structure in question. The processes currently utilized to attempt to minimize this increase in weight are costly and time-consuming.

Only a limited number of materials can be easily joined by means of melting materials, and often a very specific environment is necessary to achieve this joint. Because of this limit, current methods cannot utilize the ideal material properties required for the specific application because trade-offs must be made to ensure that a joint is possible.

Joints formed by melting materials tend to have significantly lower fatigue lives than that of the parent material. This is due to an increase in stress concentrators. These stress concentrators can take the form of impurities in the weld itself. They also exist due to the fact that welds are often made at the edge of two parts, each of which must have some form of edge which can create internal corners.

With the shrink fitting process, no heat-treatment process is necessary as the material will not be heated to a great enough temperature to create a phase change. Shrink fitting is an exact process for which the exact amount of material can be placed exactly where it is desired as opposed to the melted material techniques. Any metal can be joined with a shrink fit. Shrink fitting also does not have much of a problem with fatigue life. Thus, the shrink fitting process is a faster and cheaper assembly process than the current techniques and the shrink fit process has the potential for creating lighter and stronger structures due to the exact nature of assembly that can be applied to a virtually unlimited number of materials.

### SUMMARY OF THE INVENTION

A process for joining components of the foundational structure of a vehicle which relies upon the process of shrink fitting. An advantage of this process is the decrease in time and expense, exact control over the amount of material used, and an ability to use a much wider range of materials.

Other features and advantages of the present invention will become apparent from the following description of the invention which refers to the accompanying drawings.

### BRIEF DESCRIPTION OF THE FIGURES

FIG. 1 shows one embodiment of the present invention prior to joining.

FIG. 2 shows one embodiment of the present invention after joining.

### DETAILED DESCRIPTION OF THE PREFERRED EMBODIMENTS

Selected embodiments of the present invention will now be explained in detail with reference to the drawings. It will be apparent to those skilled in the art from this disclosure that the following descriptions for the present invention are provided for illustration only and not intended for the purpose of limiting the invention as defined by the appended claims and their equivalents.

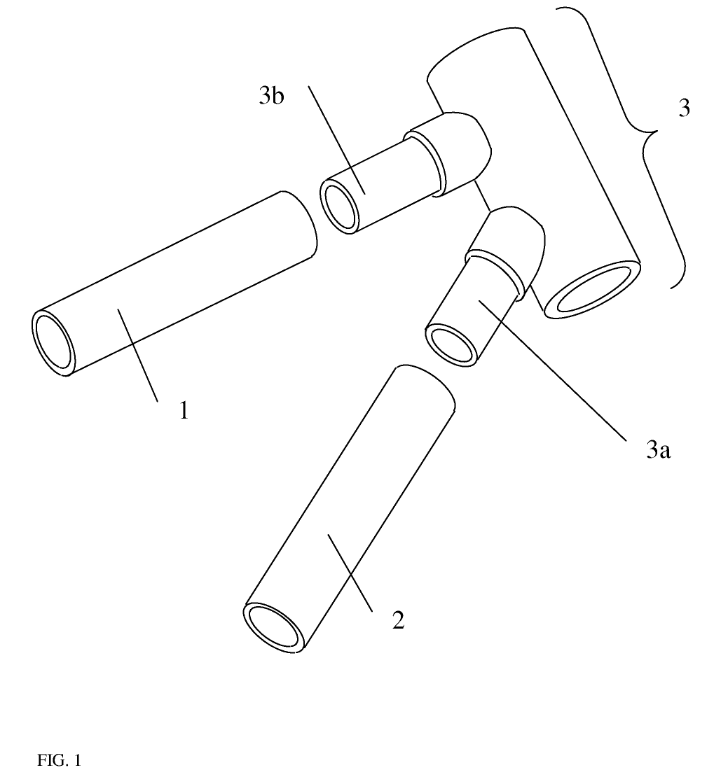

Referring to the embodiment shown in FIG. 1, two hollow tubes 1 and 2 are aligned to be joined to a joint 3 to form an example of an application of this process which takes the form of the front of a bicycle. At ambient temperature, the inner diameter of the hollow tubes 1 and 2 are smaller than the outer diameter of the protrusions 3a and 3b. Prior to assembling the these three components, the hollow tubes 1 and 2 must be heated to the point where they have expanded such that the inner diameter of the hollow tubes 1 and 2 are larger than the outer diameter of the protrusions 3a and 3b.

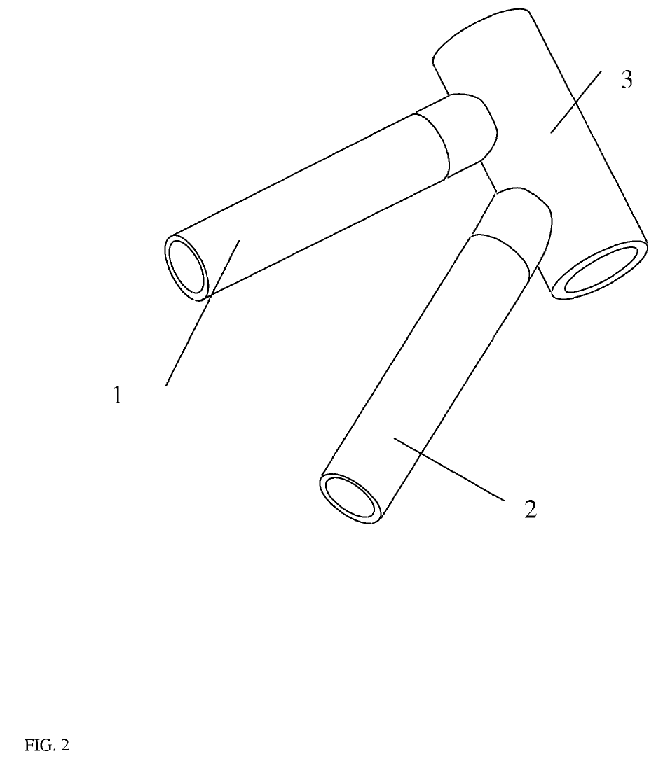

Referring to the embodiment shown in FIG. 2, two hollow tubes 1 and 2 have been aligned to be joined to a joint 3 to form an example of an application of this process which takes the form of the front of a bicycle. With the hollow tubes 1 and 2 and the joint 3 at ambient temperature, interference exists between the components along the area of contact.

What is claimed is:

1. A process for joining components in the assembly of the foundational structure of a vehicle of motion, such as a bicycle, scooter, motorcycle, moped, car, truck, trolley, pushcart, or other such vehicle of motion as powered by an individual, engine, or motor, by means of initially requiring a larger cross-sectional area for the inserted component than exists on the receiving component. Then, by means of creating a temperature differential for which the receiving component is at a great enough temperature that the resulting thermal expansion brings about an increase in cross-sectional area that will be large enough to accept the inserted component's cross sectional area, the two components can be easily slid together.

2. The process of claim 1, wherein the component is composed of a plastic, metal, ceramic, and/or composite.

3. The process of claim 1, wherein the inserted component is not of the same material as the receiving component.
